(19) United States
(12) Patent Application Publication
(10) Pub. No.: US 2007/0015684 A1
(43) Pub. Date: Jan. 18, 2007

(54) Viscosity improvement in liquid fabric softeners

(76) Inventors: Michael L. Marshall, Phoenix, AZ (US); Pamela Lam, Scottsdale, AZ (US)

Correspondence Address: THE DIAL CORPORATION, 15501 N. DIAL BOULEVARD, SCOTTSDALE, AZ, 85260, US

(21) Appl. No.: 11/182,106

(22) Filed: Jul. 15, 2005

(51) Int. Cl. C11D 3/00

(52) U.S. Cl. 510/515

(57) ABSTRACT

The present invention provides a stable, relatively low concentration of an aqueous fabric softening composition having a viscosity of from about 30 cps to about 2000 cps. The composition has a pH such that it is microbial stable and of commercially acceptable viscosity. This invention is predicated on the discovery that the use of weak acids such as lactic or citric to reduce the pH of the composition not only gives appropriate microbial efficacy but does not adversely affect the use of viscosity enhancing agents and the viscosity of the finished product is easily controlled.

### TECHNICAL FIELD OF THE INVENTION

The present invention relates to liquid fabric softening compositions and particularly to aqueous rinse cycle fabric softening compositions which are physically stable and possess a commercially desirable level of viscosity.

### BACKGROUND OF THE INVENTION

In commercial liquid fabric softeners rheological properties of the product are very important for consumer acceptance. This is particularly important when the softener product has a lower level of softener solids and is water like in viscosity. Such a product although likely to be effective as a softener is viewed as undesirable by the consumer. A common method of enhancing the product is to increase the apparent viscosity of the liquid softener to a value of at least about 30 cps (measured on a Brookfield Viscometer, LV #1 Spindle @ 60 rpms). Cationic linear or crosslinked polymers are known to act as additives to provide viscosity in liquid fabric softeners. In published application US 2004/0116322 there are disclosed concentrated aqueous fabric softening compositions comprising a mixture of polymers comprising a cationic linear homopolymer or linear copolymer and a cationic crosslinked polymer. The crosslinked polymer is a crosslinked copolymer of acrylamide and methacrylate with 150 ppm of methylene bisacrylamide and a molecular weight of below 5 million prior to the crosslinking. The polymer is commercially available as FLOSOFT DP 200 by SNF FLOERGER of France.

In such liquid fabric softening compositions it has been found desirable to add a strong acid such as phosphoric or hydrochloric acid to lower the pH of the liquid softener to improve the microbial efficacy of the product. Although the phosphoric acid lowers the pH of the product it also has the adverse effect of significantly lowering the viscosity of the product below acceptable levels. This is true even though the aforesaid mentioned FLOSOFT DP 200 viscosity agent was employed in the product.

It is has also been found that the use of a strong acid such as phosphoric gives inconsistent pH results. Moreover, once the desired pH is overshot, that is, to go lower than desired, it is very difficult to bring the pH back to specification.

Thus, there is a need to provide a liquid fabric softener which is physically stable, of appropriate viscosity and of a pH which provides microbial efficacy.

### SUMMARY OF THE INVENTION

The present invention provides a stable, relatively low concentration of an aqueous fabric softening composition having a viscosity of from about 30 cps to about 2000 cps. The composition has a pH such that it is microbial stable and of commercially acceptable viscosity. This invention is predicated on the discovery that the use of weak acids such as lactic or citric to reduce the pH of the composition not only gives appropriate microbial efficacy but does not adversely affect the use of viscosity enhancing agents such as FLOSOFT DP 200 or INCROSOFT 8000. Thus the viscosity of the finished product is easily controlled.

In a preferred embodiment the cationic softening ingredient is a fatty quaternary ammonium compound available from CRODA, Inc. called INCROSOFT T-90. This compound has the INCI name QUATERNIUM 53 and has the empirical formula:

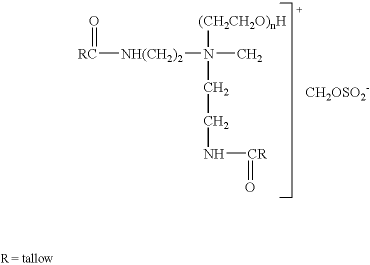

Another cationic compound that can be used as a softening ingredient is available from STEPAN Company and is called ACCROSOFT 550-75. The chemical name is methyl bis (tallowamido ethyl) -2 hydroxycthyl ammonium methyl sulfate having the structure:

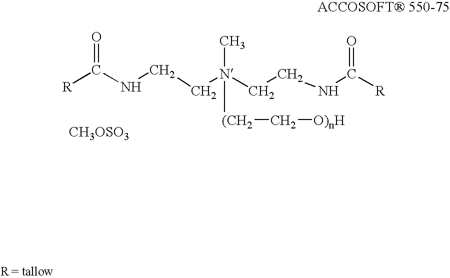

The present invention also encompasses the use of esterquat compounds as a softening ingredient and having the following structural formula: 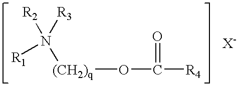
wherein R4 represents an aliphatic hydrocarbon group having from 8 to 22 carbon atoms, R₂ and R₃ represent (CH₂)—R₅ where R₅ represents an alkoxy carbonyl group containing from 8 to 22 carbon atoms, benzyl, phenyl, (C1-C4)-alkyl substituted phenyl, OH or H; RI represents (CH₂)ₜ R₆ where R₆ represents benzyl, phenyl, (CI-C4)-alkyl substituted phenyl, OH or H; q, s, and t, each independently, represent an integer from 1 to 3; and X⁻ is a softener compatible anion.

A useful esterquat is available from Stepan Company and called STEPANTEX VT90.

In a preferred embodiment the ingredients used to enhance viscosity of the composition are cationic polymer based thickeners that are known to be able to increase the viscosity of fabric softening composition. More specifically these polymers are modified polyacrylamide emulsions in mineral oil and are commercially available under the trademark INCROSOFT 8000 from Croda, Inc. and under the trademark FLOSOFT 200 from SNF FLOERGER of France. Each of the viscosity control agents are crosslinked copolymers of acrylamide and methacrylate with 150 ppm of methylene bisacrylamide and a molecular weight of below 5 million before crosslinking. These ingredients are typically used in a concentration ranging from 0.05% to about 5.0%.

### EXAMPLES

### Example I

The following formula was prepared to demonstrate the effect of using phosphoric acid to reduce the pH of the composition:

| Ingredient | Amount (Wt. %) |
|---|---|
| Cationic softener (INCROSOFT T-90) | 3.5 |
| Fragrance | 0.1 |
| INCROSOFT 8000 polymer | 0.06 |
| Dye | 0.0008 |
| Phosphoric acid | 0.045 |
| Antifoam | 0.006 |
| Preservative | 0.05 |
| Water | balance |

It was found that with a pH of 2.7 or less, the composition was unstable; that is the water and cationic separated and the viscosity was very low at about 10 cps.

### Example II

The following formula was prepared to demonstrate the effect of using a weak acid (citric) on the viscosity of the finished product.

| Ingredient/Order of Addition | Amount (Wt. %) |
|---|---|
| Water | 96.44 |
| Cationic softener (INCROSOFT T-90) | 3.15 |
| Fragrance | 0.24 |
| Citric acid solution | 0.085 |
| Flosoft 200 polymer | 0.06 |
| Antifoam | 0.002 |
| Dye | 0.008 |
| Preservative | 0.025 |

The foregoing composition was adjusted with citric acid to a pH ranging from 3.0 to 3.5 resulting in viscosities ranging from 270 to about 305 cps. The composition was stable with no separation. It should be noted from the above examples that citric acid is far more effective than phosphoric acid in reducing the pH of the composition without adversely affecting the viscosity provided by the polymers (INCROSOFT 8000 and FLOSOFT 200).

### Example III

A series of fabric softening compositions were prepared using INCROSOFT 8000 as a viscosity control agent (0.06% by Wt.) and using phosphoric, lactic and citric acids for pH control. All formulas were the same except for the use of different acids. The viscosity of the various formulas follow.

| | | | | Viscosity* |
|---|---|---|---|---|
| Formula with | | Viscosity* | Viscosity* | using |
| INCROSOFT | | using | using | Phosphoric |
| 8000 | pH | Lactic Acid | Citric Acid | Acid |
| 1 | 2.7 | 86 cps | 55 cps | 24 cps |
| 2 | 3.0 | 100 plus** cps | 95 cps | 63.5 cps |
| 3 | 3.3 | 100 plus** cps | 100 plus** cps | 100 plus** |
| | | | | cps |
| 4 | 3.6 | 100 plus** cps | 100 plus** cps | 100 plus** |
| | | | | cps |

**Viscosity is off the scale using the LV #1 spindle @ 60 rpm, 77° F.

It is desirable to have the pH of the softener composition in the range of from 2.3 to 3.7 to prevent growth of microbes. The cationic softening chemicals support such growth.

1. A stable, relatively low solids concentration of an aqueous fabric softening composition, said composition having a pH such that it is microbial stable and having a viscosity from at least about 30 cps comprising:
a) at least about 0.5% by weight of a cationic fabric softener;
b) from about 0.05% by weight to about 5.0% by weight of a viscosity control agent;
c) an amount of a weak acid such that the composition is microbial stable;
d) from about 0% to about 4% by weight of one or more adjuvants selected from the group consisting of dyes, fragrance, preservative and anti-foam; and
e) the balance water

2. The composition of claim 1 wherein said cationic softener is a fatty quaternary ammonium compound.

3. The composition of claim 1 wherein said catiohic softener is an esterquat.

4. The composition of claim 2 wherein said viscosity control agent is a corsslinked copolymer of acrylamide and methacrylate with 150 ppm of bisacylamide.

5. The composition of claim 1 wherein said weak acid is selected from the group consisting of lactic and citric acids and mixtures thereof and wherein the pH of the composition ranges from about 2.3 to about 3.7
